(19) United States
(12) Patent Application Publication
(10) Pub. No.: US 2010/0019458 A1
(43) Pub. Date: Jan. 28, 2010

(54) PISTON RING

(75) Inventors: Johannes Esser, Odenthal (DE); Frank Münchow, Wermelskirchen (DE)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL BURSCHEID GMBH, Bursheid (DE)

(21) Appl. No.: 12/527,082

(22) PCT Filed: Jan. 30, 2008
(86) PCT No.: PCT/DE2008/000163

§ 371 Date: Aug. 13, 2009

(30) Foreign Application Priority Data
Feb. 17, 2007 (DE) 10 2007 007 961.5

(51) Int. Cl. F16J 9/26

(52) U.S. Cl. 277/443; 277/442

(57) ABSTRACT

A piston ring, having a base body, which comprises a substantially circumferential running surface, an upper and a lower flank surface, and an inner circumferential surface, wherein the transitional region of the running surface is provided with an edge ≦0.1 mm in the lower flank surface, and the running surface is provided with at least one PVD cover layer ≦10 μm.

The invention concerns a piston ring, with a main body, which exhibits essentially a circular contact surface, an upper and a lower side surface, and an inner circumferential surface.

The patent DE 102 07 148 A1 discloses a piston ring involving a base material of stainless steel, in which the base material exhibits an upper and a lower side surface, a contact surface, and an inner circumferential surface. Each of these surfaces involves a nitride layer formed on it, in which each nitride layer is first formed so that it has a join layer and a diffusion layer; then the diffusion layer of the contact surface is exposed by removing the join layer and subsequently an hardplate deposition layer of hard ceramic is developed on the exposed diffusion layer.

The formation of the lower contact edge of a piston ring is of great importance for oil management in a combustion engine. It is a challenge in manufacturing the piston ring to produce as small an edge as possible, in order to obtain as good a stripping effect as possible during engine operation. Such small and sharp edges enable an uncoated ring to be produced relatively simply. Although today, coated rings are fundamentally necessary in the first groove of combustion engines. Herewith there is a conflict of goals between the desired small operating edge and a blow-by- and crack-free coated edge. All the procedures introduced up to now for manufacturing a wear-protection layer require an edge size of at least 0.15 mm in the base material for a sufficient thickness of the wear-protection layer to be produced, in order to eliminate layer ruptures or cracks in this area.

One known way to manufacture smaller contact edges is the use of fully or one-sided recessed rings, which however bring with them a disadvantage, that a certain portion of the contact surface is not principally required to be provided with a wear-protection coating, and in this area, time and again there occurs so-called firing trace build-up.

The goal of the invention subject matter is to develop a piston ring, so that by optimizing the wear-protection layer obtaining during use, especially in the area of the lower, at-risk contact edge, blow-by at the wear-protection layer is very broadly eliminated.

This problem is solved by means of a piston ring with a main body, which exhibits essentially a circular contact surface, an upper and a lower side surface, and an inner circumferential surface, whereby the transition area of the contact surface is provided at least on the lower side surface with an edge of ≦0.1 mm and the contact surface at least is provided with at least one PVD coating layer of ≦10 μm.

Advantageous developments of the invention subject matter may be inferred from the subclaims.

Physical-vapor-deposition (PVD) coating is a process in which the coating of the contact surface of the piston ring occurs by means of deposition from the vapor phase. The coating material being deposited exists, at the same time, as a stream of ionized particles.

It is an especial advantage that the PVD coating layer is based on nitrides of elements in groups IV B to VI B of the periodic table. Optionally, the elements Al and/or Si and/or C and/or O can be added.

If the main body is made of cast iron or cast steel, the edge is advantageously produced by mechanical working. Especially with steel rings, always rounded edges are present on drawn steel shapes, which only undergo mechanical working later, in order to bring about the desired effect in the transition area of the contact surface on the respective side surface.

Similarly, this essentially holds true for cast rings as well. Preferred PVD coating layers are formed on a base of CrN and/or CrON. Especially advantageous are so-called diamond-like carbon (DLC) coatings, which are applied to the contact surface of piston rings in the PVD process.

With the invention subject matter, piston rings made of cast or steel materials are provided with a lower edge of <0.1 mm with a proportionally thin wear-protection layer. Preferably, an all-around nitriding of the piston ring can be done with this wear-protection layer, in which however other known procedures (galvanic or thermal coating) are also conceivable.

Over this wear-protection layer, the proper PVD coating layer can then be applied in a thickness of ≦10 μm. PVD-multilayers are also conceivable.

In contrast to prior art, a blow-by- and crack-free edge can be produced in a precisely manufactured transition area of the contact surface, at least on the lower side surface, in connection at least with the PVD coating layer. By analogy with an uncoated ring, the oil management of a combustion engine can be positively influenced by means of these steps.

The subject matter of the invention is represented with the aid of one embodiment in the drawing. Shown are:

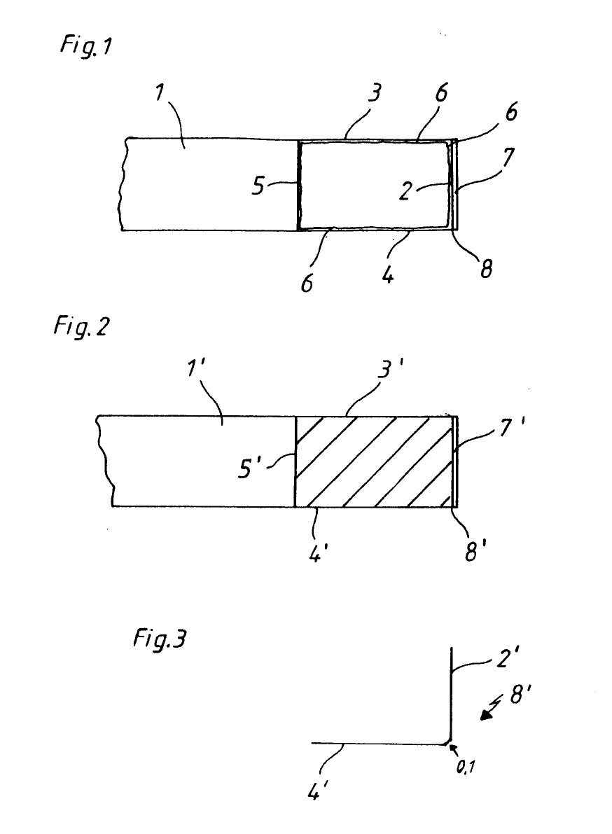

FIG. 1 A piston ring in cross-section, with an all-around wear-protection layer and a PVD coating layer in the area of the contact surface;

FIG. 2 A piston ring in cross-section, with a PVD coating layer in the area of the contact surface;

FIG. 3 A representation of the lower edge area according to FIG. 2.

FIG. 1 shows a piston ring 1 in cross-section. The piston ring 1 exhibiting a main body made of steel, cast steel, or cast iron involves a contact surface 2, an upper 3 and a lower side surface 4, and an inner circumferential surface 5. In this example, the piston ring 1 may be provided with a wear-protection layer 6 produced by nitriding in the area of its surfaces 2,3,4,5. This wear-protection layer 6 may in this example exhibit a thickness of 10 μm. In the area of the contact surface 2, a PVD coating layer 7 formed on a base of CrN is deposited on this wear-protection layer 6, which in this example exhibits a thickness of 8 μm. As an alternative wear-protection layer 6, layers produced thermally or galvanically can also be introduced, in which thermal layers are preferably applied only to the contact surface 2, whereas galvanic layers can be applied to the contact surface 2 and also to the side surfaces 3 and 4. The PVD coating layer 7 can also be of alternative materials, such as CrON. The professional expert will predetermine a suitable material combination as well as the layer thickness needed, depending on the application. The transition area 8 of the contact surface 2 on the lower side surface 4 is nearly formed as a sharp edge.

FIG. 2 shows a piston ring 1′ which, by analogy with FIG. 1, exhibits a contact surface 2′, an upper side surface 3′, a lower side surface 4′, and an inner circumferential surface 5′. In this example, a PVD coating layer 7′ based on CrON is deposited directly on the contact surface 2′, which in this example exhibits a thickness of 10 μm. The piston ring 1′ in this example is steel, in which the transition area 8′ of the contact surface 2′ on the lower side surface 4′ is provided with an edge of 0.1 mm maximum. As previously described, alternative materials can also be introduced to generate the PVD coating layer 7′.

FIG. 3 shows a detail of FIG. 2. Seen are the contact surface 2′, the lower side surface 4′, and the transition area 8′. The edge produced here may, as is indicated, amount to a maximum of 0.1 mm on the contact-surface and side-surface sides. By means of the edge shape selected in the transition area 8′ in connection at least with the PVD coating layer 7′ (FIG. 2), by optimizing the oil/management of a combustion engine, a very extensive freedom from cracks and blow-by of the PVD coating layer 7′ can be accomplished in this transition area 8′.

1. A piston ring, with a main body, which exhibits an essentially circular contact surface, an upper and a lower side surface, and an inner circumferential surface, in which a transition area of the contact surface is provided at least on the lower side surface with an edge of ≦0.1 mm and the contact surface at least is provided with at least one PVD coating layer of ≦10 μm.

2. A piston ring according to claim 1, wherein the main body consists of steel, cast iron, or cast steel, and that the transition area is produced by means of mechanical working.

3. A piston ring according to claim 1 wherein the PVD coating layer is formed on a base of CrN CrON, or CrN and CrOn.

4. A piston ring according to claim 1, wherein the PVD coating layer is based on nitrides of elements in groups IV B to VI B of the periodic table.

5. A piston ring according to claim 1, wherein the PVD coating layer is formed as a friction- and wear-resistant PVD-DLC (diamond-like carbon) layer.

6. A piston ring according to claim 1, wherein the PVD coating layer exhibits a layer thickness of 0.5 to 8 μm.

7. A piston ring according to claim 1, wherein the main body exhibits at least one wear-protection layer on which the PVD coating layer is deposited.

8. A piston ring according to claim 1, wherein the wear-protection layer is applied galvanically or thermally or by nitriding to the main body.

9. A piston ring according to claim 1, wherein the wear-protection layer exhibits a thickness of ≦30 μm, 10 to 15 μm.

10. A piston ring according to claim 3, including addition of at least one leemet to the base of nitride elements selected form the group consisting of Al, Si, C and O.

11. A piston according to claim 9, wherein the thickness is 10 to 15 μm.
